(19) United States
(12) Patent Application Publication
(10) Pub. No.: US 2012/0190118 A1
(43) Pub. Date: Jul. 26, 2012

(54) COMPONENT HAVING A PROTECTIVE LAYER THAT CAN BE MONITORED MAGNETICALLY AND METHOD FOR OPERATING A COMPONENT

(75) Inventors: Thomas Huettel, Juelich (DE); Robert Vassen, Herzogenrath (DE); Willem J. Quadakkers, Eg Wijnandsrade (NL)

(73) Assignee: Forschungszentrum Juelich GmbH, Juelich (DE)

(21) Appl. No.: 13/498,447

(22) PCT Filed: Aug. 10, 2010
(86) PCT No.: PCT/DE2010/000951

§ 371 Date: Mar. 27, 2012

(30) Foreign Application Priority Data
Sep. 29, 2009 (DE) 10 2009 043 370.8

(51) Int. Cl. G01N 27/72; B32B 15/04

(52) U.S. Cl. 436/73; 428/469; 428/629

(57) ABSTRACT

A component for high-temperature use comprises a metallic base material and a non-ferromagnetic protective layer arranged thereon, which is able to form a protective oxide layer on the component surface at temperatures between 600° C. and 1100° C. A sensor material is introduced into the protective layer, wherein, in the stated temperature range, the local magnetism, notably ferromagnetism or ferrimagnetism, at the site of the sensor material is dependent on the local concentration and/or composition of the material of the protective layer in the immediate vicinity of the sensor material and/or on the cumulative temperature-time curve at the site of the sensor material. The component can be examined non-destructively, from the outside, for the local magnetism in the protective layer, which is typically between 100 μm and 500 μm thick.

The invention relates to a component for high-temperature use, which is equipped with a protective layer against corrosion and oxidation, wherein this protective layer can be magnetically monitored non-destructively, and to a method for operating a component at a high temperature.

### PRIOR ART

When operating gas turbines and high-temperature equipment, high temperatures and corrosive atmospheres result in oxidation or corrosion of the metallic materials that are used (Ni-based alloys; high-temperature-resistant, low-alloy and high-alloy steels). So as to minimize oxidation and extend the service life of the components, protective layers of various types (overlay and diffusion layers) are applied. Frequently used layer systems include protective layers of the MCrAlY type (M=Ni, Co, Fe). The exact concentrations are dependent on the respectively required combination of oxidation/corrosion resistance and mechanical properties. The protective layers used most widely on high-temperature components are of the NiCoCrAlY type.

The oxidation/corrosion protection is based on the fact that the MCrAlY protective layer systems form a protective Al₂O₃ layer on the component surface at the high operating temperatures (typically 600 to 1100° C.) during operation of the equipment. After long operating times, progressing oxide formation or interdiffusion between the base material and protective layer results in the depletion of the protective layer-forming element aluminum, which is usually present in the form of aluminum-rich secondary phases (reservoir phases; typically of the β-NiAl or γ′-Ni₃Al type) in the protective layer. As long as the aluminum content in the layer does not drop below a minimum value, a protective Al₂O₃ layer can form again on the surface of the layer material. Drastically accelerated, often times suddenly occurring, non-protecting oxidation, with ensuing quick failure of the component, occurs below this minimum value.

Because both the rate of oxidation and interdiffusion increase with time and temperature, aluminum depletion likewise increases with time and temperature. It has not been possible until now to track this depletion process using non-destructive test methods that are suitable in practice. If this were possible, reliable information could be obtained about the remaining service life of equipment components, which thus would allow the timely replacement or recoating of the gas turbine components at typical maintenance intervals, before the component fails completely. This would lead to considerable economic advantages for the operators of the corresponding equipment.

Laboratory experiments have been used to determine data regarding the dependency of the loss of aluminum as a function of the time and temperature in typical MCrAlY layers. This data, however, relates to isothermal loading. In real equipment, drastic variations occur in the operating temperatures during long-term operation, for example when the thrust of an airplane or the output of an electricity plant must be regulated, No reliable aluminum depletion can be derived from the isothermal laboratory data for these complicated temperature/time variations. In addition, the temperature distribution on the turbine components, such as the guide vanes and rotor blades, can vary locally quite drastically. This is due, amongst others things, to locally varying wall thicknesses and/or flow profiles and the presence of cooling bores.

Methods have been available for determining the state of damage by measuring the change in the magnetic properties of the protective layer. To this end, the magnetic permeability of the layers is determined, which changes as a result of the depletion of aluminum and chromium.

However, these methods have the drawback that the layers having high chromium and aluminum contents must be very severely depleted of the two elements for a phase to occur in the layers which is ferromagnetic at room temperature and which is responsible for the change in magnetic permeability. Because purely oxidative stress of a layer, without any attendant deposition-induced corrosion, only results in aluminum depletion, the end of the service life of a layer may be reached without being able to determine this non-destructively by means of the methods used heretofore.

### Problem and Solution

It is therefore the object of the invention to provide a component in which the operation-induced wear of the protective layer which forms a protective oxide layer with high-temperature use can be monitored more reliably than according to the prior art. It is a further object of the invention to provide a method for operating a component which results in lower maintenance costs than methods according to the prior art.

### Subject Matter of the Invention

As part of the invention, a component for high-temperature use was developed. This comprises a metallic base material and a protective layer arranged thereon, which is able to form a protective, and here notably a gas-tight, oxide layer on the component surface at temperatures between 600° and 1100° C.

According to the invention, a sensor material is introduced in the protective layer wherein, in the stated temperature range, the local magnetism, notably ferromagnetism or ferrimagnetism, at the site of the sensor material is dependent on the local concentration and/or composition of the material of the protective layer in the immediate vicinity of the sensor material and/or on the cumulative temperature-time curve at the site of the sensor material. The protective layer on the component can be examined non-destructively from the outside for the local magnetism in the protective layer, which is typically between 100 μm and 500 μm thick.

The only requirement for this examination is that the protective layer does not exhibit the same magnetic behavior as the sensor material, so that the state of the sensor material can be detected by magnetic measurement. For example, if the sensor material is ferromagnetic or ferrimagnetic, the material of the protective layer should not be ferromagnetic, so as to ensure that the magnetic measurement signal originating from the sensor is not superimposed with an interference signal from the material of the protective layer. The metallic base material is not subject to any restrictions in terms of the magnetism thereof, because methods for measuring the magnetism in the protective layers are available which are limited, in terms of the extent of the information thereof, to the thickness of the protective layer or less.

The local magnetism of a site in the protective layer shall be understood to mean the functional dependency of the magnetization of this site on a magnetic field that is externally applied during the examination of the protective layer. For this examination, it is primarily relevant to distinguish whether the site exhibits ferromagnetic, ferrimagnetic, anti-ferromagnetic or paramagnetic behavior. The examination is generally carried out at room temperature. The sensor material general exhibits exclusively paramagnetic behavior in the temperature range between 600 and 1100° C. According to the invention, however, the interaction of the sensor material with the remaining material of the protective layer in this temperature range is decisive for the magnetic behavior that develops after cooling to room temperature.

The sensor material can, for example, be such that, due to the crystal structure thereof, for example, it has a ferromagnetic or ferrimagnetic phase which, in the stated temperature range, is thermodynamically stable only if certain components of the protective layer in the immediate vicinity of the sensor material are present in the correct concentration ranges. If the concentrations of these components change, the ferromagnetic or ferrimagnetic phase transforms into a phase exhibiting different magnetic behavior.

The sensor material can, for example, also be such that it reacts with certain components of the protective layer in the stated temperature range, whereby a ferromagnetic or ferrimagnetic phase is formed. To this end, the sensor material can, for example, be a metallic element which forms an intermetallic phase with a material from the protective layer. If the metal in the protective layer depletes, this intermetallic phase disappears, and along with it the ferromagnetism or ferrimagnetism effected by it. The sensor material can, for example, also be a ferromagnetic material having an oxidic coating, which in the stated temperature range remains thermodynamically stable only in the presence of certain components in the protective layer. The ferromagnetic material is protected from transformation or destruction by the coating only while these components are present in the protective layer in sufficient quantities. Once these components deplete, the sensor material is transformed or disintegrated, and it loses the ferromagnetism thereof.

The sensor material, however, can also be an oxide of a ferromagnetic or ferrimagnetic material, for example, which undergoes a redox reaction with a metallic element in the protective layer (such as aluminum, for example, in an MCrAlY protective layer). The oxide is reduced in the process, whereby the magnetism thereof is changed. The metallic element in the protective layer is oxidized and can cover the reduced oxide with a protective layer. This ensures that the reaction product does not disassociate in the layer matrix (for example, of the MCrAlY type). The kinetics of the redox reaction are such that this takes place gradually, on a long-term time scale, which may be in the range of weeks or months, because the reaction rate is defined by the diffusion rate of the metal or oxygen through the developing oxidic reaction layer (such as aluminum oxide, for example). The reaction rate is therefore highly dependent on temperature. The change in the magnetism is thus decisively dependent on the temperature change over time at the site of the sensor material. How strongly any customarily used protective layer material wears with a particular temperature change over time is known from laboratory experiments. The speed at which local depletion of aluminum progresses at a particular temperature is known especially for MCrAlY protective layers. In this embodiment of the invention, the gradual change, which can be monitored from the outside, in the magnetism at the site of the sensor material is thus not only a measure of the cumulative time-temperature stress at this site, but also a measure of the local wear of the protective layer. For example, immediately after the protective layer is produced, ferromagnetism may be present in the sensor material, which then gradually vanishes. However, it is also possible, for the sensor material to not initially be ferromagnetic after the protective layer is produced, and become gradually ferromagnetic as the cumulative stress increases.

The interaction of the sensor material with the material of the protective layer determines, at the respective site of each formula unit of the sensor material, what magnetic behavior this formula unit will exhibit after cooling to room temperature during the examination of the protective layer from the outside. The contributions of several such formula units distributed in the protective layer add up and form macroscopically observable magnetic behavior of the protective layer. All embodiments of the invention share the common idea of rendering the macroscopically observable magnetic behavior of the protective layer sensitive to the characteristic variables of the protective layer that are of interest, by introducing an additional sensor material in the protective layer, whereby these characteristic variables can be better detected metrologically than according to the existing prior art.

It has been found that the local magnetization at the site of the sensor material, and thus the macroscopically observable magnetic behavior of the protective layer, reacts with considerably greater sensitivity to damage of the protective layer, or to the cumulative temperature-time stress thereof, than the development of a ferromagnetic phase in the material of the protective layer itself, which used to be an indicator of the damage to the protective layer. Additionally, this measured variable also responds more quickly to such damage or stress than it takes for a ferromagnetic phase to form in the protective layer itself. In the example of a protective layer containing both chromium and aluminum, which is mentioned in the prior art, a ferromagnetic phase that can be detected from the outside does not develop in the protective layer until, as a result of operation, both the chromium and aluminum have been substantially consumed. The majority of application-relevant corrosion processes, however, attack only the aluminum, and not the chromium. The failure of the layer is thus based on selective oxidation of the aluminum, and thus on the consumption of this protective layer component, without any considerable consumption of chromium. If according to the invention the local magnetism at the site of the sensor material is dependent on the local aluminum concentration, which is dependant on the local aluminum consumption, the emerging failure of the protective layer can be detected at an early stage, contrary to the prior art.

In a particularly advantageous embodiment of the invention, the local magnetism at the site of the sensor material is thus specifically dependent on the local concentration and/or composition of a component of the protective layer which is consumed during high-temperature use as a result of operation.

A person skilled in the art will generally be aware of which metallic base material is used and which material the protective layer is made of, based on the mechanical and thermal requirements to which the component is subjected in the specific application case. The skilled practitioner will thus also know which components of the protective layer make sense to monitor for depletion by introducing a sensor material according to the invention, so as to detect any emerging failure of the protective layer, and thus of the component, at an early stage. In order to carry out the teaching according to the invention, the skilled practitioner must therefore find a sensor material in which the magnetism thereof can be influenced in the stated temperature range by the interaction with the components of the protective layer which are to be monitored. A person skilled in the art of high-temperature-resistant metallic materials will be sufficiently familiar with the phase diagrams for such metals, the ferromagnetic elements generally contained therein and the components of the protective layer. Without undue experimentation, he will thus be able to find the correct sensor material, in particular because he can verify his success by aging the sample and making subsequent magnetic measurements in combination with the examination of metallurgical cross sections. Moreover, hereafter a person skilled in the art will be provided with several guidelines, even specific examples, for selecting the sensor material, which can each serve as starting points for additional experiments.

In a particularly advantageous embodiment of the invention, the protective layer is able to form an oxide comprising Al₂O₃ on the component surface. The protective layer advantageously contains a composition of the form MCrAlY, in which M comprises one or more elements from the group consisting of Fe, Co, and Ni. In such protective layers, the aluminum is the first element to run low as a result of operation because of the aluminum-rich oxide layer that forms on the surface, and the supply of aluminum is therefore the limiting factor for the service life of the protective layer.

The protective layer advantageously contains 0 to 80 (preferably 10 to 80) mass percent of cobalt, 0 to 70 (preferably 30 to 70) mass percent of nickel, 15 to 30 mass percent of chromium, 0 to 70 (preferably 10 to 70) mass percent of iron, and 5 to 20 mass percent of aluminum. This percentage information does not refer to any compositions that contain a sum of more than 100 mass percent of elements. This information is rather intended to also include, for example, layers of the NiCoCrAlY, NiCrAlY, CoCrAlY and FeCrAlY types, in which one or more of the aforementioned elements are lacking, in favor of other elements.

The thickness of the protective layer advantageously ranges between 100 μm and 500 μm.

The base material advantageously comprises steel, notably high-temperature-resistant steel, or a nickel-based alloy. A nickel-based alloy is any alloy that contains nickel as the main constituent. The simplest nickel-based alloy comprises 80% nickel and 20% chromium. Typical commercially available nickel-based alloys used in gas turbines are alloys of the INCONEL or NIMONIC type. Examples include INCONEL 617 or NIMONIC 80A. In addition, what are known as nickel-based super alloys are used. The following shall be mentioned by way of example: IN713, IN738, CM247 and CMSX4. These materials are selected based on the excellent mechanical strength thereof at the high operating temperatures. In general, the mechanical requirements in the specific application case will establish with substantial clarity which base material, and more particularly which nickel-based alloy, is preferably used. The aforementioned base materials are generally suited for high-temperature use in the stated temperature range, provided that they are protected from oxidation and corrosion by a protective layer which is able to form a protective, and here notably a gas-tight, oxide layer on the component surface. Specifically in connection with nickel-based alloys, particularly advantageously, MCrAlY layers can be used, which are characterized by the formation of an aluminum-based surface oxide layer.

Options will be provided hereafter by way of example as to how to sensitize the local magnetism at the site of the sensor material to the local concentration and/or composition of the material of the protective layer in the immediate vicinity of the sensor material, and hence to the wear of the protective layer.

In a particularly advantageous embodiment of the invention, the local crystal structure of the sensor material is dependent on the local concentration and/or composition of the material of the protective layer in the immediate vicinity of the sensor material. The sensor material advantageously has a ferromagnetic or ferrimagnetic garnet structure, which is able to transform into structures that are different from garnets at temperatures between 600 and 1100° C., wherein the rate at which this transformation is carried out depends on the local concentration and/or composition of the material of the protective layer in the immediate vicinity of the garnet structure. This can, for example, mean that the ferromagnetic or ferrimagnetic garnet structure is thermodynamically stable while the layer material is intact, yet loses this stability after a disadvantageous change of the layer material and transitions into a different structure having considerably different magnetism, for example into a binary oxide or a perovskite structure.

Notably a structure having the empirical formula A₃B₂(CO₄)₃ is suited as the garnet structure. In this formula, A comprises one or more elements from the group consisting of Fe, Co, Ni, Mn, Cr, Y, and Mg, or a rare earth metal, B comprises one or more elements from the group consisting of Fe, Co, Al, Cr, Mg, Si, Ti, and V, and C comprises one or more elements from the group consisting of Fe, Al, Ga, Si, and Ti. The magnetism of these structures is based on the insertion of Fe, Ni, Co or rare earth metals. Garnets of this type, and more specifically Y/Al garnets, can be thermodynamically stable in protective layers that form aluminum oxide if aluminum and oxygen are dissolved in the matrix of the protective layer in suitable concentrations which define the thermodynamic activity of aluminum or oxygen. Oxidation or interdiffusion processes change the aluminum and oxygen activity. As a result, the garnet phases transform into perovskite structures or into binary oxides, whereby the magnetism changes drastically.

As an alternative or in combination therewith, in another particularly advantageous embodiment of the invention, the local chemical composition of the sensor material, in the stated temperature range, is dependent on the local concentration and/or composition of the material of the protective layer in the immediate vicinity of the sensor material.

This is achieved, for example, when advantageously the sensor material is able to form a ferromagnetic or ferrimagnetic intermetallic phase with the material of the protective layer in the stated temperature range. It is particularly advantageous when a component of the protective layer which, as a result of operation, is consumed during high-temperature use, is involved in this intermetallic phase. If depletion of this component occurs, which is an indication of imminent failure of the protective layer, the intermetallic phases disintegrate. The ferromagnetism or ferrimagnetism is lost, which can be non-destructively detected from the outside.

To this end, the sensor material advantageously can form oxides with at least one element of the protective layer, which are thermodynamically more stable than the oxide layer on the component surface. Rare earth metals such as Sm, Gd or Nd are particularly suitable for this purpose, notably in interaction with an aluminum oxide-forming protective layer. In high-temperature use, these elements tend to oxidize internally beneath the protective layer and to diffuse in the direction of the surface of the component. Every time an atom of a rare earth metal oxidizes and diffuses to the surface, the intermetallic phase which formed this atom with the aluminum of the protective layer is destroyed and no longer contributes to the local ferromagnetism or ferrimagnetism. The steady decline of the local ferromagnetism or ferrimagnetism over the entire protective layer is then an early indicator of damage of the protective layer by oxygen that penetrated from the outside as a result of operation.

For this purpose, it is particularly advantageous if the oxygen affinity of at least one element of the sensor material is greater than that of all the components (notably elements) of the protective layer which were consumed due to operation during high-temperature use. Using the example of aluminum oxide-forming protective layers, the oxygen affinity of rare earth metals, such as Sm, Gd or Nd, is greater than that of Al. At a particular supply of oxygen, the oxidation of these rare earth metals is preferred over the consumption of the aluminum and thus takes place more quickly. While a decline in the ferromagnetism or ferrimagnetism is indicative of a high number of such oxidation processes, and thus of wear of the protective layer, a safety buffer of aluminum remains, which assures protection of the component until the possibility arises for recoating or replacement.

In a further advantageous embodiment of the invention, the sensor material comprises a non-oxidic ferromagnetic or ferrimagnetic phase having an oxidic coating. The coating serves as a diffusion barrier so as to prevent the immediate disintegration of the ferromagnetic phase in the protective layer at high temperatures. This coating is advantageously designed so as to either lose the effect thereof as a diffusion barrier and/or to disintegrate when the local concentration and/or composition of the material of the protective layer changes. Once the coating has lost the effect thereof, the ferromagnetic phase oxidizes or disintegrates in the material of the protective layer, whereby the respective ferromagnetism or ferrimagnetism is lost. The ferromagnetism or ferrimagnetism detectable from the outside is thus coupled to the state of the protective layer which is to be monitored.

If the protective layer is, for example, an MCrAlY layer, the oxidic coating can be designed such that it loses the protective effect thereof upon aluminum depletion in the surrounding MCrAlY matrix. This can, for example, be effected by making the coating itself of aluminum oxide or selecting it such that it reacts with the aluminum from the protective layer at high temperatures to form aluminum oxide. At high temperatures, such a coating loses the thermodynamic stability thereof when the aluminum in the protective layer depletes. The ferromagnetic or ferrimagnetic phase enclosed in the coating is then opened up to destruction, and the macroscopically detectable ferromagnetism or ferrimagnetism decreases.

The ferromagnetic phase advantageously comprises one or more elements, compounds or alloys from the group consisting of Pt₃Cr, Fe, Co, Ni, Gd, Ni₃Mn, FePd₃, MnBi, MnB, ZnCMn₃, AlCMn₃ and MnPt₃. The oxidic coating advantageously comprises one or more elements or compounds from the group consisting of Al₂O₃, Cr₂O₃, Fe₂O₃, Fe₃O₄, FeO, NiO, Co₂O₃, CoO, TiO₂, SiO₂, MnO, and MgO, or a mixed oxide of these oxides. Using Pt₃Cr as an example of the ferromagnetic phase, the coating can be applied either by pre-oxidation and formation of Cr₂O₃ or by means of a coating method, such as sputtering or vapor deposition.

As an alternative or in combination with the preceding embodiments of the invention, the local chemical composition of the sensor material, and thus the local magnetism at the site of the sensor material, can be coupled to the cumulative temperature-time stress at the site of the sensor material. For this purpose, in another advantageous embodiment of the invention, the sensor material comprises an oxide which changes the magnetism thereof, or is able to form new phases having changed magnetic properties, in the stated temperature range, by reacting with the material of the protective layer. Examples of such oxide systems include Fe₂O₃, Fe₃O₄, FeO, CoO, Co₂O₃, NiO or mixed oxides (amongst others, spinels, garnets, hexaferrites and perovskites) containing Fe and/or Co and/or Ni, and additionally may contain further elements (for example, Cr, Si, Mg, Mn, Ti, Al, Hf, Zr, Y, Ca, and rare earth metals). The oxide can, for example, undergo a redox reaction with a metal in the protective layer, such as aluminum with protective layers that are able to form gas-tight Al₂O₃ layers on the surfaces thereof. Such a reaction reduces the oxide (for example, FeO) and also oxidizes the metal (for example, Al), whereby notably the oxidized metal can form a protective shell around the reduced oxide, protecting the oxide from fast transformation or disintegration in the protective layer.

The reaction of the oxide with the material of the protective layer takes place on a very slow time scale, which may be in the range of weeks or months. This applies in particular when the reaction is a redox reaction. Each individual formula unit of the oxide immediately changes the magnetism thereof when it is reacted. Over time, an increasing number of formula units are reacted. From a macroscopic view point, the magnetism of the protective layer therefore changes gradually. For example, the sensor material can be ferromagnetic immediately after it is introduced in the protective layer and can slowly lose this ferromagnetism as the cumulative temperature-time stress increases. Conversely, as this stress progresses, the material may gradually form ferromagnetism that was not present at the beginning.

This constitutes an essential qualitative difference over the previous embodiments of the invention, which are sensitive to the local concentration and/or composition of the material of the protective layer. Those embodiments supply digital yes/no information as to whether certain conditions prevail in the protective layer. Here, the magnetism now changes gradually with the rising cumulative temperature-time stress of the protective layer. The magnetism of the sensor material is therefore not a yes/no indicator, and instead a continuous operating time meter, which in addition to time also takes the temperature-dependent intensity of the stress into consideration. Precisely this consideration of the temperature curve over time is of particular importance for the ability to maintain technical equipment. In most technical applications, temperature stress is distributed very irregularly over the surface of the component. On a length scale of several centimeters, temperatures may vary by 100° C. or more. As a result, the wear of the protective layer is also very locally irregular. By being able to capture the cumulative local temperature-time stress according to the invention, exactly those locations on the surface of the component which require reconditioning can be determined. Additionally, the distribution of the stress over the surface of the component allows conclusions to be drawn as to how the technical equipment may be reconditioned to the effect that the stress of the protective layer is more uniform.

In general, the cumulative temperature-time stress of the protective layer can be used to determine the depletion of those materials that are consumed during high-temperature use as a result of operation. Laboratory experiments exist for any conventional protective layer material, and notably for MCrAlY, in which the depletion was measured as a function of the cumulative temperature-time stress and the depletion rate was measured as a function of the current temperature. For the particular cumulative temperature-time stress, the degree of depletion can again be read from this data relating to the kinetics of the depletion process. The option created according to the invention, of measuring the cumulative temperature-time stress magnetically from the outside, thus forms a bridge between this laboratory data and technologically tangible testing and maintenance intervals as well as state-dependent maintenance.

In a particularly advantageous embodiment of the invention, the sensor material is designed as a layer within the protective layer, which preferably runs parallel to the oxide layer on the surface of the component. The sensor material is then sensitive to damage to the protective layer at the defined depth at which the layer made of the sensor material runs. For graduated early detection, notably several layers made of sensor materials that have differing magnetic properties may be arranged at differing depths inside the protective layer. By way of the differing magnetic feedback information from the various layers made of sensor material, it is then possible, from the outside, to establish the depth at which the damage to the protective layer has already occurred. For this purpose, the structure and/or the composition of the sensor material can advantageously exhibit a continuous monotonic function curve as a function of the depth inside the protective layer.

The invention further relates to a method for operating a component, wherein this component comprises a metallic base material and a protective layer arranged thereon, and wherein this protective layer is able to form a protective, notably gas-tight, oxide layer on the component surface at temperatures between 600° C. and 1100° C. According to the invention, a sensor material is introduced in the protective layer so that, in the stated temperature range, the local magnetism, notably ferromagnetism or ferrimagnetism, at the site of the sensor material is dependent on the local concentration and/or composition of the material of the protective layer in the immediate vicinity of the sensor material and/or on the cumulative temperature-time curve at the site of the sensor material. The component is subsequently operated in the stated temperature range, for example in the intended use thereof in a machine that is subjected to high temperatures, such as a gas turbine. After the component has cooled to a suitable temperature, the magnetism of the protective layer, and more particularly the ferromagnetism or ferrimagnetism, is measured. What temperature is suited will be dependent on the phase diagram of the sensor material. For example, if the sensor material is ferromagnetic or ferrimagnetic, measuring makes sense only considerably below the Curie temperature of the sensor material. The measurement is advantageously carried out at a temperature at which the component can be touched using one's hand without special protective measures, which in general is thus at room temperature.

The time at which the measurement is carried out should be selected so that failure of the component will not be expected at that time, even when assuming the least favorable conditions, and any corresponding safety margins. Failure of a turbine blade in the gas turbine, for example, in general results in the destruction of the entire turbine.

It was found that the method can be used to reliably inspect the component as to whether it is still suitable for continued high-temperature use, or whether the protective layer on the component should be renewed or the component should be completely eliminated. Likewise, the method can be used to establish the time at which the next inspection should take place.

The consequence of this is that the component no longer requires replacement, purely prophylactically, after a predetermined time, or no longer requires reconditioning by renewing the protective layer. Instead, the time for these cost-intensive measures, which are associated with a shutdown of the machine, can be tailored to the actual state of wear of the protective layer on the component. In addition, with the method according to the invention, the intervals at which the component is inspected are no longer necessarily rigidly linked to a number of days, or to a number of operating hours. Instead, these intervals can now also be established based on the actual wear level. This has inherent economic benefits, notably for machines subject to highly varying stress in day-to-day business. The stress of an airplane turbine depends, for example, on the flight schedule and the weather. Just how strong the stress to which the gas turbine in a power plant is subjected is depends on the power requirement and the supply of wind power.

So as to achieve the stated advantages, the sensor material can, for example, be selected such that the local magnetism at the site of the sensor material is specifically dependent on the local concentration and/or composition of a component of the protective layer which is consumed during high-temperature use as a result of operation. This consumption takes place primarily with constant regeneration of the protective oxide layer. Once the component is exhausted, this regeneration is no longer possible, and failure of the component is imminent. The remaining supply of the component is thus a measure of the time period during which the component can continue to be used at high temperatures until it must be repaired or replaced.

The sensor material can in particular be selected such that, in the stated temperature range, the local crystal structure of the sensor material is dependent on the local concentration and/or composition of the material of the protective layer in the immediate vicinity of the sensor material. As an alternative or in combination therewith, it may also be selected such that, in the stated temperature range, the local chemical composition of the sensor material is dependent on the local concentration and/or composition of the material of the protective layer in the immediate vicinity of the sensor material and/or on the cumulative temperature-time curve at the site of the sensor material. Because of the coupling to the temperature-time curve, for example, it is possible to count the operating hours of the component, in combination with the respective thermal stress.

The respective measurement can be carried out in a spatially resolved manner. This advantageously can accommodate the circumstance that individual regions of the component experience drastically varying thermal stresses and the protective layer thus wears very irregularly over the surface of the component.

All other measures and materials which are disclosed in the claims relating to the component and the associated description can be applied with like effect in the method. In a particularly advantageous embodiment of the method, for example, notably a component according to one of the product claims can be selected as the component.

In a particularly advantageous embodiment of the invention, the protective layer on the component is renewed, or the component is eliminated, when the magnetism exceeds or falls below a predetermined threshold during the measurement. This threshold can be established in advance, for example based on laboratory experiments conducted on the protective layer material, so that the protective layer still has a safety margin, in terms of service life, established by technical standards, when this threshold is reached.

In a particularly advantageous embodiment of the invention, the protective layer is exposed to a magnetic field having two components of differing frequencies in order to measure the magnetism. The amplitude of the low-frequency component of the magnetic field is advantageously selected high enough to periodically urge the ferromagnetic component of the material present in the protective layer to go into saturation. The superposition of the two magnetic field frequencies can then be used selectively for detecting the ferromagnetic (sensor) material in the protective layer.

For this purpose, the high-frequency component of the magnetic field is advantageously selected to have a frequency between 10 MHz and 30 MHz, or between 10 and 100 kHz. A frequency between 0 and 100 Hz, and more particularly a frequency of 22 Hz, is preferably selected for the low-frequency component of the magnetic field.

### SPECIFIC DESCRIPTION

The subject matter of the invention will be described in more detail hereafter based on figures, without thereby limiting the subject matter of the invention. In the drawings:

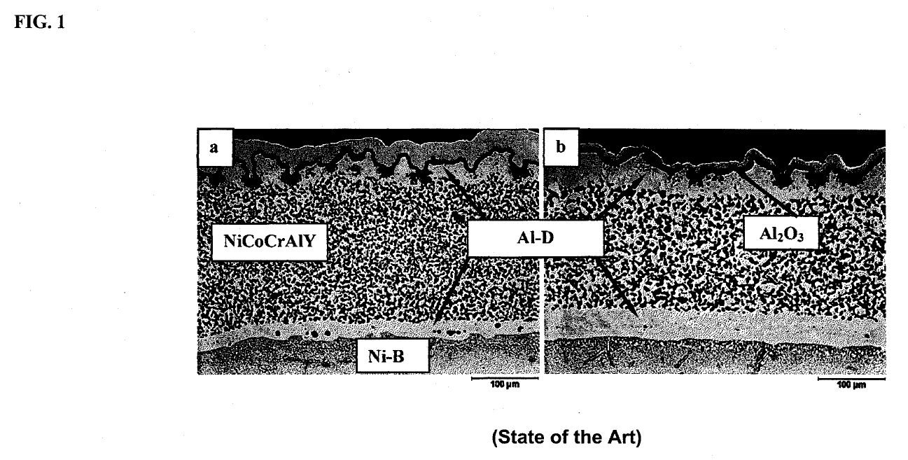

FIG. 1: shows metallographic cross sections of two different NiCoCrAlY protective layers (a and b) on a gas turbine component after use at 1000° C.;

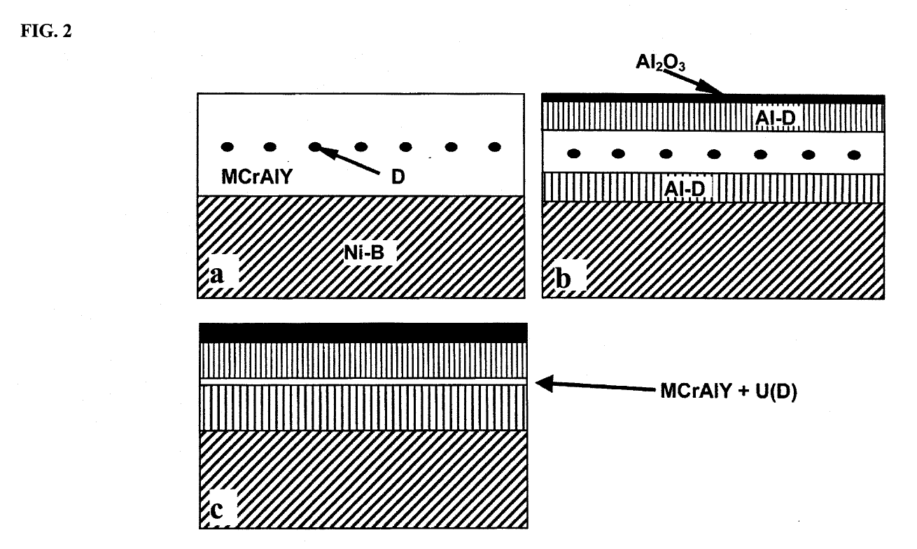

FIG. 2: is an exemplary embodiment of the component according to the invention, comprising a layer made of sensor material within the protective layer: (a) state after production; (b) state after brief high-temperature use; (c) state after longer high-temperature use and complete consumption of the aluminum-containing reservoir phase 8-NiAl in the protective layer;

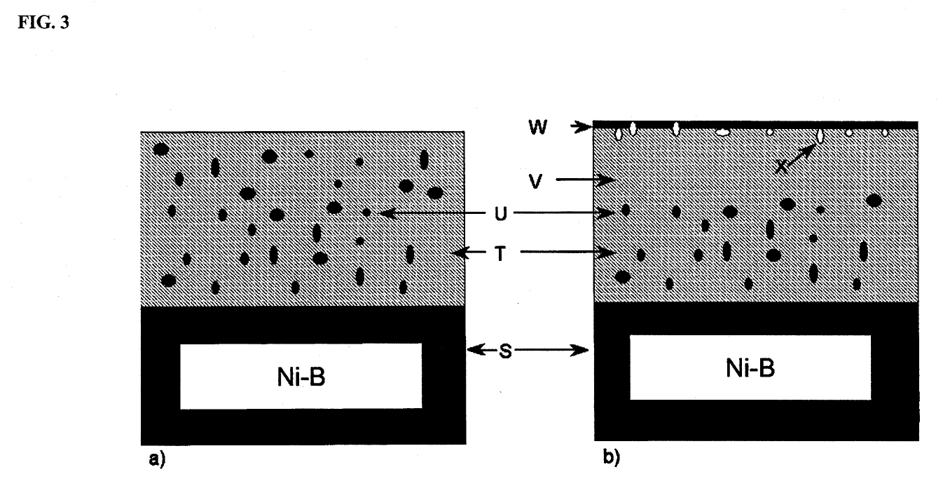

FIG. 3: is an exemplary embodiment of the component according to the invention comprising a sensor material which forms a ferromagnetic intermetallic phase with the aluminum from the NiCoCrAlY protective layer: (a) state after production; (b) state after high-temperature use; and

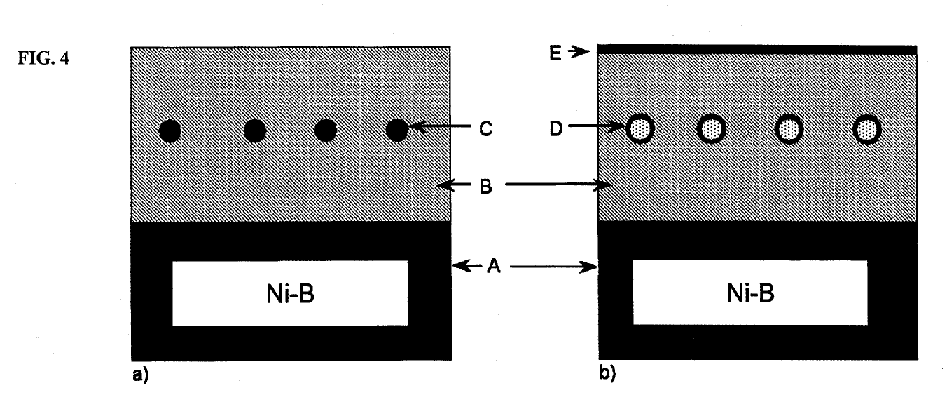

FIG. 4: is an exemplary embodiment of the component according to the invention comprising a sensor material which is sensitive to the cumulative temperature-time stress: (a) state after production; (b) change of the sensor material during operation.

In sub-images a and b, FIG. 1 shows two different examples of NiCoCrAlY protective layers on a gas turbine component (nickel-based super alloy, Ni-B) after use at 1000° C., clarifying the problem that is solved according to the invention. The metallographic cross sections show aluminum depletion zones Al-D due to oxide formation (top) and interdiffusion with the base material (bottom). Despite aluminum depletion, the protective Al₂O₃ layer continues to be formed, as desired, in the examples shown. This regeneration is no longer possible only once the aluminum in the protective layer has been almost completely consumed. The amount of reservoir phases of the layer-forming element Al (shown in dark here) still remaining in the layer at a particular time, however, cannot be detected from the outside using existing methods. According to the invention, an option is provided for measuring this remaining amount either directly or indirectly. It is thus possible to estimate the remaining operating time until complete failure of the protective layer.

FIG. 2 shows a schematic design of an exemplary embodiment of the component according to the invention. The component is equipped with a protective system comprising NiCoCrAlY (MCrAlY), which forms Al₂O₃ at high temperatures, with sensor material D being integrated according to the invention. The sensor material D is introduced locally in the protective layer in the form of inclusions, or it is designed as a layer within the protective layer. Sub-image a shows the initial state after production of the layer system. Sub-image b shows the state that is reached after brief aging at high temperature in air or, for example, a combustion atmosphere. A gas-tight Al₂O₃ layer has formed on the protective layer. An aluminum depletion zone Al-D has formed below this Al₂O₃ layer due to oxidation. Another aluminum depletion zone Al-D has formed on the interface with the base material due to interdiffusion of the aluminum with the base material. As the aging duration increases, the two depletion zones grow toward each other. As soon as one of the depletion zones has reached the layer made of the sensor material D (sub-image c), this is transformed, according to the invention, into a transformation product U(D) having a changed crystal structure and/or chemical composition, whereby the magnetic properties thereof change. By way of this change, it is possible to detect from the outside that the component is in need of repair.

FIG. 3 shows another exemplary embodiment of the component according to the invention. An MCrAlY layer T is applied to the substrate S, which here is a nickel-based alloy. According to the invention, the layer contains inclusions made of a sensor material. These inclusions, together with the aluminum from the protective layer, form a ferromagnetic intermetallic phase U, which is integrated in the protective layer, still in the form of inclusions. The ferromagnetism of this layer system is at a maximum immediately after production (sub-image a). During the subsequent high-temperature use (sub-image b), an Al₂O₃ layer W forms on the surface of the protective layer. Additionally, several of the inclusions U oxidize due to oxygen penetrating from the outside and form oxides X, which diffuse to the surface. These oxides are no longer ferromagnetic. They leave a zone V behind in the protective layer T, the zone being depleted of ferromagnetic intermetallic inclusions U. As the duration of the high-temperature use progresses, the overall ferromagnetism that can be detected from the outside thus steadily decreases. This decrease is a measure of the damage of the protective layer T by oxygen having penetrated from the outside.

It was proven experimentally that adding, by alloying, less than 1 mass %, and preferably less than 0.8 mass %, of Sm, Gd or Nd to MCrAlY protective layers leads to the formation of an additional ferromagnetic intermetallic phase. In the experiment, the protective layer contained 28 mass % of Ni, 24 mass % of Cr, 10 mass % of Al and, in some samples, also 0.4 mass % of Y, with the quantity remaining under 100% being Co in each case. Sa in the amount of 0.6 mass % was added by alloying. The intermetallic phase has a high content of Ni, Co and Sm/Gd/Nd and, at the same time, is low in Al and Cr. The β-NiAl and γ-Ni phases also present in the system remain without influence by the addition of Sm/Gd/Nd by alloying, because these elements are fully bound in the newly formed intermetallic phase. High-temperature aging in oxidizing atmospheres results in the formation of an outer Al₂O₃ layer on the Sm/Gd/Nd-MCrAlY layer system. The adhesion of this oxide layer is insufficient with high Sm/Gd/Nd contents (overdoping), but excellent at lower contents. At the same time, inner oxidation of Sm/Gd/Nd beneath the Al₂O₃ layer occurs. The inner oxides are both pure Sm/Gd/Nd oxide and mixed oxides comprising aluminum and these elements. The elements added by alloying thus act as reactive elements, comparable to the element Y frequently added to coatings. Because of the oxidation of the reactive elements added by alloying, the intermetallic phases formed from Sm/Gd/Nd (inclusions U in FIG. 3) disintegrate, whereby a characteristic depletion zone of these phases (denoted by V in FIG. 3) forms beneath the outer oxide layer. This depletion zone no longer contributes to the local ferromagnetism of the protective layer, whereby the ferromagnetism of the protective layer decreases in the overall. The protective effect of the outer Al₂O₃ layer is preserved.

FIG. 4 shows another exemplary embodiment of the component according to the invention. An MCrAlY layer B is applied to the substrate A, which here is a nickel-based alloy. A phase C made of an oxidic sensor material is present locally here (sub-image a). During high-temperature use (sub-image b), during which the Al₂O₃ layer E also forms on the surface of the protective layer, this sensor material undergoes a redox reaction with the aluminum from the protective layer. The sensor material is reduced and thus becomes ferromagnetic. At the same time, the aluminum is oxidized and forms a shell around the, now ferromagnetic, sensor material. The sensor particles along with the shell are denoted by the symbol D in sub-image b. This reaction takes place gradually on a scale ranging from weeks to months and progresses more quickly the higher the current temperature is. The change in magnetism at the site of the sensor material, which here is a gradual rise in ferromagnetism, is thus encoded with the cumulative temperature-time stress of the protective layer at the site of the sensor material. A depletion of aluminum in the protective layer due to oxygen having penetrated from the outside into the protective layer, in contrast, has only minor influence on the rate at which the redox reaction takes place because of the high oxygen content in the sensor phase.

An oxidic sensor phase (a phase comprising an oxidic sensor material) was already successfully introduced in a commercial MCrAlY protective layer material in experiments. This material contained 30 mass % of Ni, 30 mass % of Cr, 8 mass % of Al, and 0.6 mass % of Y. The amount remaining under 100% was Co. To this end, ferromagnetic Fe₃O₄ particles were integrated in the material, whereby the originally paramagnetic protective layer at the respective sites of the particles became ferromagnetic. The macroscopic ferromagnetism, which is composed of the contributions of the individual particles, could be measured successfully and clearly at Fe₃O₄ contents of a few mass percent. Fe₃O₄ contents of less than 10 mass %, and preferably of less than 5 mass %, proved to be advantageous. In contrast, the results measured were poorer at an Fe₃O₄ content of 20 mass %. After high-temperature aging (2 hours at 1100° C.), a thin, well-adhering Al₂O₃ layer, comprising a β-depletion zone underneath, formed on the outer surfaces of the MCrAlY with added Fe₃O₄. A depletion zone of comparable size is likewise present around the Fe₃O₄ particles in the interior of the MCrAlY. This depletion zone was created by the reaction of the aluminum from the MCrAlY with the oxidic Fe₃O₄ sensor phase. The Fe₃O₄ particles were chemically reduced by aluminum, whereby FeO, amongst others, developed. At the same time, an Al₂O₃ layer formed around the sensor phase. Additionally, a transition zone made of Fe—Al spinel is located between the sensor phase and the Al₂O₃ layer surrounding the same. The phase transitions within the sensor phase caused the magnetic properties of the MCrAlY to change significantly. The content of ferromagnetic Fe₃O₄ decreased, while paramagnetic phases, such as FeO or Al₂O₃, developed, whereby the macroscopically observable ferromagnetism decreased.

Because the reduction of Fe₃O₄ (and of other oxides that are thermodynamically unstable in the presence of aluminum) in an MCrAlY matrix is temperature-dependent, it was concluded that such systems can be utilized as a local temperature sensor so as to assess the thermal stress of MCrAlY layers. The cumulative temperature-time stress manifests itself in the macroscopically observable ferromagnetism, which can be utilized as an operating time meter with added temperature dependence.

Analogous experiments in which the sensor phase was not Fe₃O₄, but rather FeO, showed that pure Fe had formed after 2 hours at 1100° C. due to the reaction of the sensor with aluminum from the MCrAlY, the Fe being surrounded by a thin Al₂O₃ layer. The result achieved by this was that the macroscopic ferromagnetism increases, instead of decreases, as the temperature-time stress progresses.

Examples of sensor phases:
oxides containing a metal: FeO, Fe₂O₃, Fe₃O₄, NiO, CoO, Co₂O₃, Gd₂O₃
mixed oxides containing several metals (with each oxide having Fe, Co or Ni, either partially or fully, in at least one of the lattice positions A, B or C):
Spinets: AB₂O₄ A: Fe, Co, Ni, Cr, Mg, Mn, Mo, Sr, Ti, V, Zn, Cu
   B: Fe, Co, Ni, Cr, Mg, Mn, Mo, V, Al
A₂BO₄ A: Fe, Co, Ni
   B: Si, Ti, Mn, Ge, Hf, Mo, Sn, Zr
Garnets: A₃B₂(CO₄)₃ A: Fe, Co, Ni, Mg, Ca, Mn, Cr, Y, Gd, Nd, Er, Yb, Ho, Tm, Dy, Sm, Tb, Ce
   B: Fe, Co, Al, Cr, Ga, Mg, Si, Ti, V, Zr
   C: Fe, Al, Ga, Si, Ti
Perovskites: ABO₃ A: Ca, Mg, Sr, Gd
   B: Fe, Ti, Si
Hexaferrites: AB₁₂O₁₉ A: Sr, Ba, Pb
   B: Fe, Co, La, Zn
Other mixed oxides: FeTiO₃, olivine group (Mg,Mn,Fe)₂[SiO₄1, CoSiO₂

Examples of production methods:
various variants of plasma spraying (vacuum, low-pressure, atmospheric plasma spraying and the like)
flame spraying
sputtering of the sensor phase and/or of the coating
sputtering onto the sensor phase (using oxide or, for example, aluminum→due to pre-oxidation, transformation into Al₂O₃)
vapor deposition onto the sensor phase (using oxide or, for example, aluminum→due to pre-oxidation, transformation into Al₂O₃)
laser cladding
detonation spraying
cold gas spraying
sol-gel deposition of the sensor phase
vapor deposition of the sensor phase
welding/overlay cladding
spraying/brushing on the sensor phase
pressing/hot pressing/sintering/powder metallurgy
introducing the sensor phase in a material by means of fusion-metallurgical methods
pack cementation or gas phase alitization or chromization.

A non-oxidic, ferromagnetic phase having an oxidic coating was introduced experimentally. It was possible to demonstrate that suitable non-oxidic sensor phases disintegrate very quickly in MCrAlY when no diffusion barrier is present. The integration of ferromagnetic SmCo₅ in commercial MCrAlY resulted in fast disintegration of the sensor phase due to the action of the high temperature, because unimpaired interdiffusion with the MCrAlY matrix took place. After the ferromagnetic phase disintegrated, the ferromagnetism disappeared in the MCrAlY.

The method applied for measuring the magnetism in the protective layer is based on exposing the material to be examined to a magnetic field having two frequencies. The high-frequency component of the magnetic field preferably has frequencies between 10 MHz and 30 MHz, or between 10 and 100 kHz. The low-frequency component, which preferably has frequencies between 0 and 100 Hz, and more particularly a frequency of 22 Hz, periodically causes the ferromagnetic (sensor) material in the protective layer to go into saturation. This frequency mixing makes possible reliable distinction between paramagnetic/diamagnetic phases and ferromagnetic phases. The lateral spatial resolution of the measurement method is 1 to 2 mm, depending on the selected measurement frequency. The penetration depth and depth resolution are 1 μm to several 100 μm, depending on the selected measurement frequency.

1.-41. (canceled)

42. A method for monitoring a component, comprising a metallic base material and a protective layer arranged thereon, which contains aluminum and has the composition of MCrAlY, in which M comprises one or more elements from the group consisting of Fe, Co, and Ni, the protective layer being able to form a protective, notably gas-tight, oxide layer on the component surface during high-temperature use at temperatures between 600° C. and 1100° C. and depleting aluminum during high-temperature use due to operation,
a sensor material is added to the protective layer, the material reacting with the aluminum from the protective layer during the intended use, whereby the existing ferromagnetic or ferrimagnetic magnetism thereof changes or a new phase having a ferromagnetic or ferrimagnetic property is formed,
the protective layer is subjected to magnetic measurement multiple times, and
the time results of the magnetic measurements allow conclusions to be drawn regarding the depletion state of aluminum in the protective layer.

43. The method according to claim 42, wherein the protective layer has a layer thickness between 100 μm and 500 μm.

44. The method according to claim 43, wherein a component made of steel, notably high-temperature-resistant steel, or made of a nickel-based alloy is used.

45. The method according to claim 42, wherein at least one metallic element is added to the protective layer as the sensor material, which is able to form a ferromagnetic or ferrimagnetic intermetallic phase with the aluminum from the protective layer, and the concentration of this intermetallic phase is measured using the magnetic measuring method.

46. The method according to claim 45, wherein one or more rare earth metals are used as the metallic elements, notably Sm, Gd or Nb, for the sensor material.

47. The method according to claim 42, wherein at least one oxide of a ferromagnetic or ferrimagnetic material is added to the protective layer as the sensor material, which undergoes a redox reaction with the aluminum from the protective layer and thus changes the magnetism thereof, and the concentration of the oxide of the ferromagnetic or ferrimagnetic material is measured using the magnetic measuring method.

48. The method according to claim 47, wherein Fe₂O₃, Fe₃O₄, FeO, CoO, Co₂O₃, NiO or mixed oxides containing Fe and/or Co and/or Ni are used as the sensor material.

49. The method according to claim 42, wherein a ferromagnetic or ferrimagnetic sensor material having a garnet structure is added to the protective layer, the sensor material undergoing a reaction with the aluminum from the protective layer during which the garnet structure is transformed into a different structure, the magnetism of which differs from that of the garnet structure, and the concentration of the ferromagnetic or ferrimagnetic garnet structure is measured using the magnetic measuring method.

50. The method according to claim 49, wherein a compound having the empirical formula A₃B₂(CO₄)₃ in a garnet structure is added as the sensor material, where A comprises one or more elements from the group consisting of Fe, Co, Ni, Mn, Cr, Y, Mg, and C, or a rare earth metal, B comprises one or more elements from the group consisting of Fe, Co, Al, Cr, Mg, Si, Ti, and V, and C comprises one or more elements from the group consisting of Fe, Al, Ga, Si, and Ti.

51. The method according to claim 42, wherein at least one non-oxidic ferromagnetic or ferrimagnetic phase having an oxidic coating is added to the protective layer as the sensor material, wherein the oxidic coating acts as a diffusion barrier so as to slow down the reaction between the non-oxidic ferromagnetic or ferrimagnetic phase of the sensor material with the aluminum from the protective layer, and the concentration of the ferromagnetic or ferrimagnetic phase is measured using the magnetic measuring method.

52. The method according to claim 51, wherein a sensor material comprising Pt₃Cr, Fe, Co, Ni, Gd, Ni₃Mn, FePd₃, MnBi, MnB, ZnCMn₃, AlCMn₃ or MnPt₃ is used as the ferromagnetic or ferrimagnetic phase.

53. The method according to claim 51, wherein a sensor material comprising Al₂O₃, Cr₂O₃, Fe₂O₃, Fe₃O₄, FeO, NiO, Co₂O₃, CoO, TiO₂, SiO₂, MnO, MgO or a mixed oxide of these oxides is used as the oxidic coating.

54. A method according to claim 42, wherein the magnetic measuring method that is carried out is measurement of the magnetism of the protective layer, wherein the protective layer is exposed to a magnetic field comprising two components having differing frequencies.

55. The method according to claim 54, wherein the amplitude of the low-frequency component of the magnetic field is selected high enough to periodically cause the ferromagnetic component of the material present in the protective layer to go into saturation.

56. A method according to claim 42, wherein the protective layer on the component is renewed, or the component is eliminated, when the results of the magnetic measurements exceed or fall below a predetermined threshold.

57. A component for high-temperature use, comprising a metallic base material and a protective layer arranged thereon, which contains aluminum and has the composition of MCrAlY, in which M comprises one or more elements from the group consisting of Fe, Co, and Ni, the protective layer being able to form a protective, notably gas-tight, oxide layer on the component surface at temperatures between 600° C. and 1100° C. and depleting aluminum during high-temperature use due to operation,
the protective layer comprises a sensor material which reacts with the aluminum from the protective layer in the stated temperature range, whereby the existing ferromagnetic or ferrimagnetic magnetism thereof changes or a new phase having a ferromagnetic or ferrimagnetic property is formed,
so that the local magnetism at the site of the sensor material is dependent on the local concentration of the aluminum from the protective layer in the immediate vicinity of the sensor material and/or on the cumulative temperature-time curve at the site of the sensor material.

58. The component according to claim 57, wherein the sensor material is designed as a layer within the protective layer.

59. The component according to claim 58, wherein the layer made of the sensor material runs parallel to the oxide layer on the surface of the component.

60. The component according to claim 58, wherein a plurality of layers made of sensor materials having differing magnetic properties are arranged at various depths within the protective layer.

61. A component according to claim 58, wherein the structure and/or the composition of the sensor material have a continuous monotonic function curve as a function of the depth within the protective layer.
